(19) United States
(12) Patent Application Publication
(10) Pub. No.: US 2015/0143470 A1
(43) Pub. Date: May 21, 2015

(54) MANAGING AN INTERFACE BETWEEN AN APPLICATION AND A NETWORK

(71) Applicants: Bryan Stiekes, Brownstown Township, MI (US); Vishwas Manral, Sunnyvale, CA (US)

(72) Inventors: Bryan Stiekes, Brownstown Township, MI (US); Vishwas Manral, Sunnyvale, CA (US)

(21) Appl. No.: 14/391,834

(22) PCT Filed: Jul. 31, 2012
(86) PCT No.: PCT/US2012/049014

§ 371 Date: Oct. 10, 2014

(51) Int. Cl. H04L 29/06

(52) U.S. Cl. CPC H04L 63/10; H04L 63/123
USPC 726/4

(57) ABSTRACT

According to an implementation, an interface between an application and a network is managed, for instance, by an interface manager. The interface manager is to receive a request from the application for access to the network, determine privileges assigned to the application, and provide the application with a level of access to the network that corresponds to the determined privileges assigned to the application.

### BACKGROUND

Modern IT systems depend heavily on the cooperation of computing and network resources to efficiently and securely deliver application services. Reliable application or service performance is highly dependent on correct definition of network access policies, the proper prioritization of critical traffic, as well as the distribution of traffic flows across horizontally scaled compute resources.

Traditional networking platforms focus on developing “application aware” network features and appliances that require device specific, discipline specific, and often manual configuration to ensure that the platforms recognize, respond to, and manipulate application traffic as required to ensure application performance, stability, and behavior. This approach, however, introduces barriers to systems development, which add cost, complexity, and time.

### BRIEF DESCRIPTION OF THE DRAWINGS

Features of the present disclosure are illustrated by way of example and not limited in the following figure(s), in which like numerals indicate like elements, in which:

FIG. 1 shows a functional block diagram of a network environment in which an interface manager disclosed herein may be implemented, according to an example of the present disclosure;

FIG. 2 shows a functional block diagram of a service topology containing an interface manager, according to an example of the present disclosure;

FIG. 3 shows a simplified block diagram of a network apparatus depicted in FIG. 1, according to an example of the present disclosure;

FIGS. 4 and 5, respectively, depict flow diagrams of methods for managing an interface between an application and a network, according to two examples of the present disclosure; and

FIG. 6 illustrates a schematic representation of a computing device, which may be employed to perform various functions of the interface manager depicted in FIG. 3, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element. Moreover, the variables “l”, “m”, and “n” are intended to denote integers equal to or greater than one and may denote different values with respect to each other.

Disclosed herein is a method for managing an interface between applications and a network that enables the applications to interact and negotiate for network services, which allow the applications to integrate into the network and participate with the network's forwarding process. In one regard, the method disclosed herein enables the applications to interact directly with the network dynamically and holistically defining and requesting required network services without requiring application developers to engage additional resources to configure specific ‘application aware’ network devices to detect and then respond to inferred application state in order to ensure application performance, stability, and behavior. In another regard, the method disclosed herein exposes the relevant context (e.g., policies, performance characteristics, statuses, topologies, etc.) for each application based on the privileges granted to the individual application or service. Also disclosed herein are an interface manager that is to implement the method and a computer readable storage medium on which is stored a set of machine readable instructions for performing the method.

Generally speaking, the interface manager is constructed on top of a trusted controller of a network of network devices and provides abstraction of network services application programming interfaces (APIs) to external application services, while also authenticating those application services to ensure that unauthorized activity by the application services is prevented. By way of example, the trusted controller and the network devices operate under a trusted protocol, such as OpenFlow™. In this regard, the trusted controller is responsible for building and loading traffic forwarding entries into each network device, such as a switch in the network. The trusted controller represents a trusted control plane, which is responsible for maintaining network state and topology. According to an example, the controller is constructed as a system of cooperating network services, which are granted trusted access to the controller's state and network actuation mechanisms via the controller and network services APIs. Moreover, the stability of the network is substantially ensured by preventing application and management services from interacting directly with the trusted controller's trusted network state, thereby preserving the core control of network function to network services.

According to an example, the application development ecosystem may be unified through exposure of the network status and capability to the application environment via the interface manager disclosed herein. In addition, the application development ecosystem may be unified in a secure, holistic, and interactive manner. In one regard, the method disclosed herein does not require that a development team engage additional highly skilled personnel responsible for understanding system function and translating that function into the relevant network configurations. In another regard, the method disclosed herein significantly reduces complexity in the behavior and design of the application development ecosystem as the necessary “programming” does not require the configuration of tens to hundreds of appliances. In a further regard, the method disclosed herein improves development and deployment as organizationally external and time-constrained resources may not need to be engaged.

In contrast, traditional networking technologies focus on building application awareness and intelligence into individual highly-functional network appliances. This requires systems to be developed without any awareness of the network status or function with a follow-on effort to correctly configure the network to ensure necessary behavior. Traditional networking technologies are therefore typically costly, complex, and time-consuming.

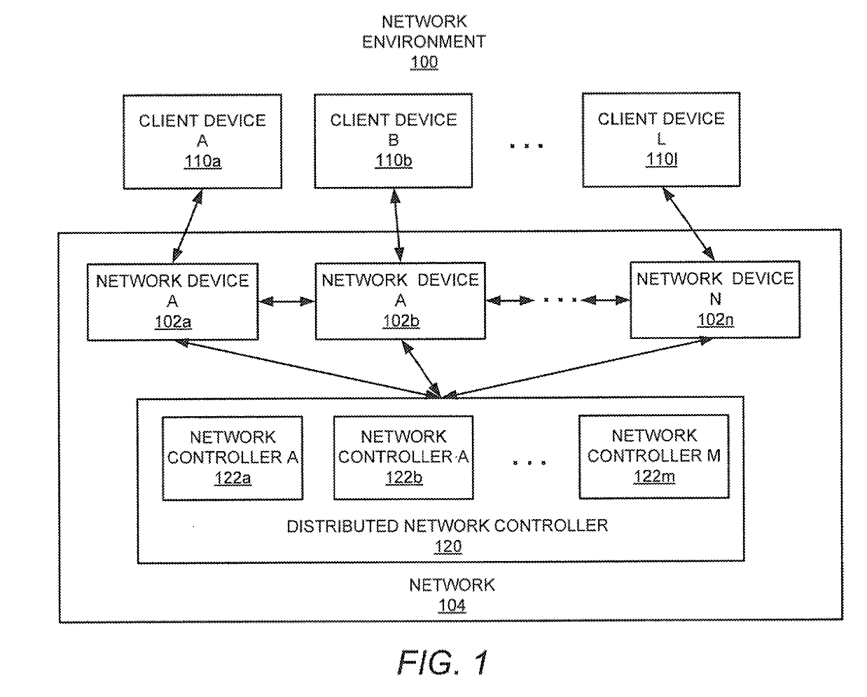

With reference to FIG. 1, there is shown a functional block diagram of a network environment 100, in which an interface manager disclosed herein may be implemented, according to an example. It should be readily apparent that the diagram depicted in FIG. 1 represents a generalized illustration and that other components may be added or existing components may be removed, modified or rearranged without departing from a scope of the network environment 100. For instance, the network environment 100 may include additional network devices, such as data storage arrays, servers, etc.

The network environment 100 is depicted as including a plurality of network devices 102a-102n, a plurality of client devices 110a-110l (which may also be termed appliances), and a distributed network controller 120 composed of a plurality of network controllers 122a-122m. The network devices 102a-102n comprise apparatuses that provide networking functions to a plurality of client devices 110a-110l in a network 104, such as, an intranet, the Internet, etc. In this regard, the network devices 102a-102n may comprise switches, routers, wireless access points, wireless controllers, hubs, bridges, servers, etc. In addition, the network devices 102a-102n are depicted as being networked to each other in one of a local area network (LAN), a wide area network (WAN), a metropolitan area network (MAN), etc. The client devices 110a-110l comprise personal computers, servers, laptop computers, tablet computers, cellular telephones, or any other electronic device that may be used to access the network 104 through the network devices 102a-102n.

The network controllers 122a-122m comprise servers, processors, network devices, etc., that are to control operations of the network devices 102a-102n in performing networking operations, such as forwarding data packets to appropriate destinations through the network devices 102a-102n, balancing loads on the network devices 102a-102n, managing bandwidth allocations to the network devices 102a-102n, network traffic prioritization, traffic flows through the network devices 102a-102n, etc. By way of particular example, the network controllers 122a-122m comprise x86 processors contained in a single or in multiple chassis. In one regard, the control of the network device 102a-102n operations is distributed across a plurality of network controllers 122a-122m for redundancy and failover purposes. However, it should be understood that the distributed network controller 120 may include a single network controller 122a without departing from a scope of the present disclosure.

According to an example, and as discussed in greater detail herein, at least one of the network controllers 122a-122m includes an interface manager (not shown) that is to provide the applications executing on the network devices 110a-110l a predefined level of access to the network 104. Particularly, the interface manager is to provide the predefined level of access to the network 104 based upon various factors, which includes an awareness of the network 104. In one regard, the interface manager is to expose network status and functionality directly to the applications executing on the network devices 110a-110l (i.e., in an application layer), which allows for the applications to interact with the network 104, react to network performance 104 and status, and/or influence network 104 behavior in an efficient and holistic manner.

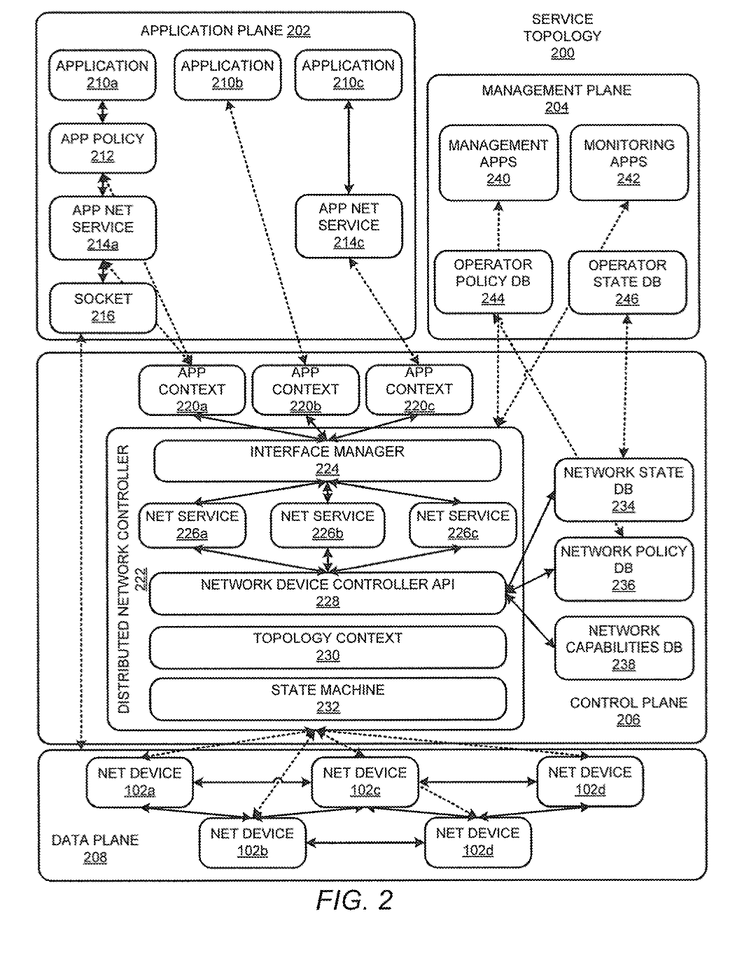

With reference now to FIG. 2, there is shown a functional block diagram of a service topology 200 containing an interface manager, according to an example. It should be readily apparent that the diagram depicted in FIG. 2 represents a generalized illustration and that other components may be added or existing components may be removed, modified or rearranged without departing from a scope of the service topology 200.

The service topology 200 is shown as including an application plane 202, a management plane 204, a control plane 206, and a data plane 208. According to an example, the service topology 200 depicts a topology of the network environment 100 depicted in FIG. 1. In this regard, various operations and functionalities of the components depicted in FIG. 1 may be construed as being controlled in the various different planes 202-208 depicted in FIG. 2. In FIG. 2, the dashed arrows generally denote that the components are logically connected to each other and the solid arrows generally denote that the components are co-located and/or that the components are physical connected to each other.

A number of applications 210a-210c are depicted as being part of the application plane 202. The applications 210a-210c may be stored in one of the client devices 110a-110l or in multiple ones of the client devices 110a-110l. In any regard, the applications 210a-210c may communicate various requests to the control plane 206 and each of the applications 210a-210c may communicate different requests to the control plane 206. As shown in FIG. 2, one of the applications 210a is to communicate various information pertaining to the application 210a, including an application policy 212 and an application network service 214a to the control plane 206, which are discussed in greater detail below. That application 210a is also depicted as communicating with the data plane 208 through a socket 216, for instance, to communicate data packets directly to the network devices 102a-102d contained in the data plane 208. Another application 210b is depicted as communicating, for instance, information pertaining to the application 210b, and a further application 210c is depicted as communicating information pertaining to the application 210c, including an application network service 214c to the control plane 206. In any regard, the applications 210a-210c may communicate with the interface manager 224 through a set of interfaces, for instance, control socket connections to the interface manager 224.

The control plane 206 is depicted as including a distributed network controller 222, which includes an interface manager 224, a plurality of network service applications 226a-226c, a network device controller application programming interface (API) 228, a topology context 230, and a state machine 232. The control plane 206 is also depicted as including a network state database 234, a network policy database 236, and a network capabilities database 238. The components of the control plane 206, and particularly, the distributed network controller 222, may comprise the components of the distributed network controller 120 in FIG. 1.

The distributed network controller 222 operates the OpenFlow™ protocol or other type of protocol to control various operations of the network devices 102a-102n (only network devices 102a-102d are shown) in the data plane 208. For instance, the distributed network controller 222 is to build and load traffic forwarding entries into each network device 102a-102n. According to an example, the network devices 102a-102n comprise switches and the network 104 comprises a switch fabric. The distributed network controller 222 represents a trusted control plane 206, which is responsible for maintaining network state and topology. In addition, the distributed network controller 222 is constructed as a system of cooperating network services 226a-226c that are granted trusted access to the distributed network controller's 222 state and network actuation mechanisms via the network device controller API 228.

As shown in FIG. 2, the interface manager 224 comprises a separate component from the network device controller API 228. Particularly, the interface manager 224 may be considered as being constructed on top of the network device controller API and as providing abstraction of network services APIs to the applications 210a-210c. The interface manager 224 may also perform authentication of the applications 210a-210c to ensure that the applications 210a-210c are authorized to perform the services that the applications 210a-210c seek to perform on the network 104. As discussed in greater detail below the interface manager 224 is responsible for exposing the relevant application contexts 220a-220c (e.g., policies, performance characteristics, statuses, topologies, etc.) for each application 210a-210c based on the privileges granted to the applications 210a-210c. The interface manager 224 exposes the relevant context 220a-220c to the applications 210a-210c while helping to ensure the stability of the network 104 by preventing the applications 210a-210c, as well as, the management services in the management plane 204, from interacting directly with the distributed network controller's 222 trusted network state, thus preserving the core control of network function to the network services 226a-226c.

The interface manager 224 generally comprises a set of machine readable instructions that operate, for instance, as a network awareness API. In other words, the interface manager 224 enables the applications 210a-210c, as well as, operating systems, to query the network 104 for network status information, in which the application context 220a-220c provided by the interface manager 224 provides a level of transparency of the network 104 (FIG. 1) to the applications 210a-210c and the operation systems. In one regard, the interface manager 224 unifies the development ecosystem by exposing network status and capability securely to the application environment. This unification enables a holistic and interactive relationship to be maintained between the application environment 202 and the network 104 that supports the application environment 202.

As shown in FIG. 2, the interface manager 224 may receive requests from the applications 210a-210c to access, i.e., query, interact, modify, etc., the network 104. The requests may include queries for status information pertaining to the network 104. The status information may include, for instance, a latency from a source to a destination or within the bounds of the network 104, available bandwidth capacities from a source to a destination or within the bounds of the network 104, status of the communications flows associated with a particular application, etc.

In addition or alternatively, the requests may define policies and requirements, for instance, relevant to the delivery and access policies to the network 104 by the applications 210a-210c. The requests may also include a negotiation with the interface manager 224 for transmission and distribution services. Examples of which include defining latency, loss, bandwidth, reliability requirements (such as not sharing link risk group), defining load balancing policies, etc. In other words, the interface manager 224 allows the applications 210a-210c to program the distributed network controller 222 to send triggers to the applications 210a-210c when certain predefined conditions defined in the policies are met.

The communications may also include requests by the applications 210a-210c to insert services into the traffic forwarding process. Fulfillment of these requests allows the applications 210a-210c to analyze traffic and, based on privilege, allows the applications 210a-210c to influence traffic forwarding decisions. Various examples pertaining to the communications and the operations performed by the interface manager 224 with regard to those communications are described in greater detail below.

As further depicted in FIG. 2, the distributed network controller 222 also communicates with components in the management plane 204. The components in the management plane 204 include management applications 240, monitoring applications 242, an operator policy database 244, and an operator state database 246. In one example, a management entity, e.g., the system operator, interacts with control plane 206 and the data plane 208 through a Graphical User Interface, SNMP, Netconf, or any other similar configuration and management protocol. Particularly, the distributed network controller 222 and the applications 240 and 242 in the management plane 204 may communicate with the management entity via socket communication, using HTTP, using HTTPS, etc.

The interface manger 224 is to provide the applications 210a-210c with levels of access to the network that correspond to the determined privileges assigned to the applications 210a-210c. In one example, and according to the privileges assigned to the applications 210a-210c, the interface manager 224 allows the applications 210a-210c to access the network state database 234, the network policy database 236, and the network capabilities database 238. In another example, the interface manager 224 allows the applications 210a-210c to access the network device controller API 228, which has access to the databases 234-238.

Although the service topology 200 depicted in FIG. 2 has been described as being directed to a particular service and a relatively network, it should be understood that the service topology 200 may also include communication between multiple systems. For instance, multiple distributed network controllers 222 may communicate with each other to enable management of interfaces between applications and networks that are managed by the distributed network controllers 222.

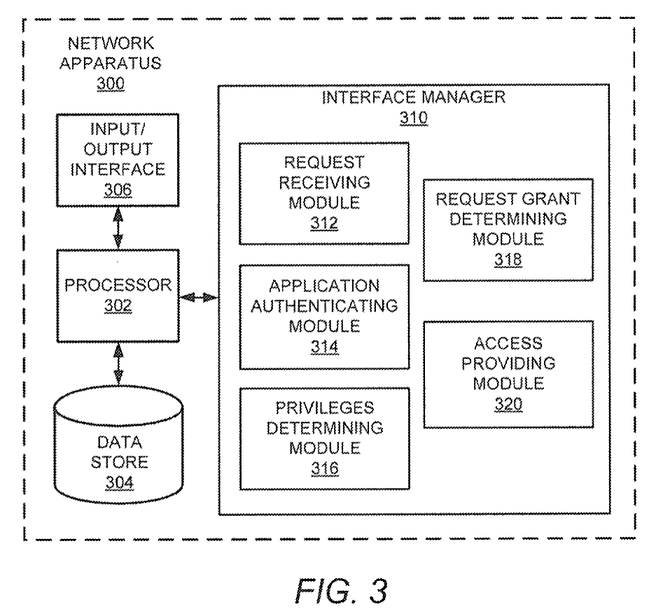

Turning now to FIG. 3, there is shown a simplified block diagram of a network apparatus 300, according to an example. It should be readily apparent that the diagram depicted in FIG. 3 represents a generalized illustration and that other components may be added or existing components may be removed, modified or rearranged without departing from a scope of the network apparatus 300 depicted therein.

Generally speaking, the network apparatus 300 may comprise a network controller 122a of the distributed network controller 120, 222 respectively depicted in FIGS. 1 and 2. In this regard, the network apparatus 300 may comprise one of a plurality of network controllers 122a-122n forming the distributed network controller 120. In another regard, the functions described herein with respect to the network apparatus 300 may be performed by a number of network apparatuses that are similarly configured as or differently configured from the network apparatus 300. In addition, although not shown, the network apparatus 300 may also have stored thereon the network services 226a-226c, the network device controller API 228, the topology context 230, and the state machine 232 discussed above with respect to the distributed network controller 222 depicted in FIG. 2.

The network apparatus 300 is depicted as including a processor 302, an input/output interface(s) 304, a data store 306, and an interface manager 310. The interface manager 310 is also depicted as including a request receiving module 312, an application authenticating module 314, a privileges determining module 316, a request grant determining module 318, and an access providing module 320. The processor 302, which may comprise a microprocessor, a micro-controller, an application specific integrated circuit (ASIC), and the like, is to perform various processing functions in the network apparatus 300. One of the processing functions includes invoking or implementing the modules 312-320 of the interface manager 310 as discussed in greater detail herein below.

According to an example, the interface manager 310 comprises a hardware device, such as, a circuit or multiple circuits arranged on a board. In this example, the modules 312-320 comprise circuit components or individual circuits. According to another example, the interface manager 310 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 312-320 comprise software modules stored in the memory. According to a further example, the modules 312-320 comprise a combination of hardware and software modules.

The input/output interface(s) 306 may comprise a hardware and/or a software interface. In this regard, the input/output interface(s) 306 may comprise either or both of hardware and software components that enable receipt and transmission of data and/or signals. Thus, for instance, the input/output interface(s) 306 comprise physical ports, such as, Ethernet ports, optical fiber ports, etc., into which cables are to be physically inserted. In another example, the input/output interface(s) 306 comprise equipment to enable wireless communication of IP packets, such as, equipment to enable Wi-Fi™, Bluetooth™, etc.

In one regard, the processor 302 is to receive data, e.g., requests, from the applications 210a-210c through the input/output interface(s) 306. The processor 302 is also to output data, e.g., application contexts 220a-220c, to the applications 210a-210 through the input/output interface(s) 306. The processor 302 may further communicate with the components 240-246 in the management plane 204, the network devices 102a-102n in the data plane 208, the network data database 234, the network policy database 236, and the network capabilities database 238 through the input/output interface(s) 306.

The processor 302 may also store the received data in the data store 304 and may use the data in implementing the modules 312-320. The data store 304 comprises volatile and/or non-volatile memory, such as DRAM, EEPROM, MRAM, phase change RAM (PCRAM), Memristor, flash memory, and the like. In addition, or alternatively, the data store 304 comprises a device that is to read from and write to a removable media, such as, a floppy disk, a CD-ROM, a DVD-ROM, or other optical or magnetic media.

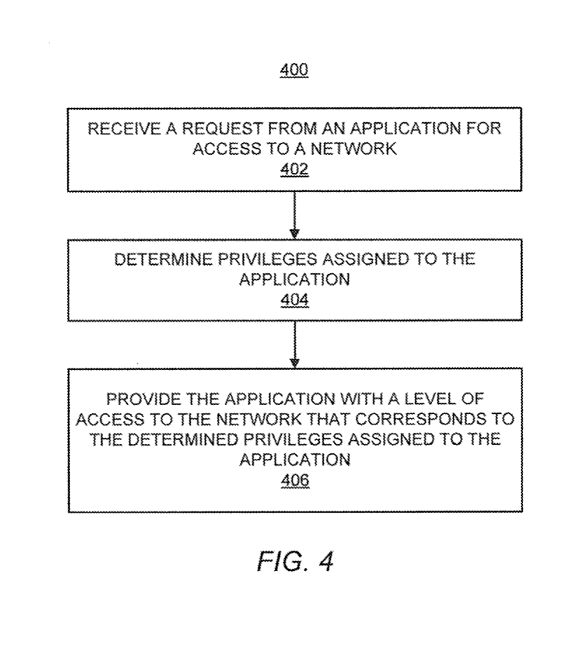

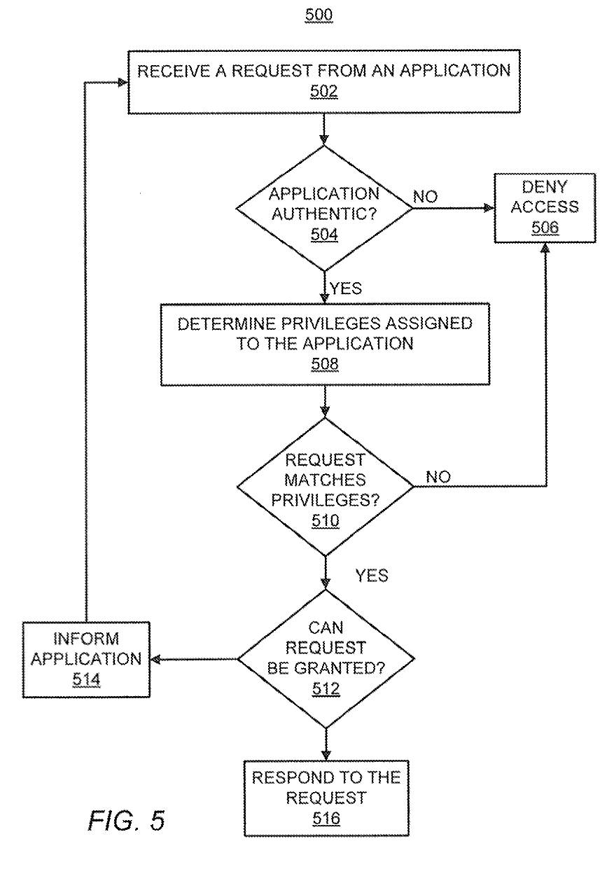

Various manners in which the interface manager 310 may be implemented are discussed in greater detail with respect to the methods 400 and 500 respectively depicted in FIGS. 4 and 5. FIGS. 4 and 5, more particularly, depict respective flow diagrams of methods 400 and 500 for managing an interface between an application and a network, according to two examples. It should be apparent to those of ordinary skill in the art that the methods 400 and 500 represent generalized illustrations and that other steps may be added or existing steps may be removed, modified or rearranged without departing from scopes of the methods 400 and 500. Although particular reference is made to the interface manager 310 depicted in FIG. 3 as comprising an apparatus and/or a set of machine readable instructions that may perform the operations described in the methods 400 and 500, it should be understood that differently configured apparatuses and/or machine readable instructions may perform the methods 400 and 500 without departing from scopes of the methods 400 and 500.

Generally speaking, the methods 400 and 500 may be implemented to manage an interface between an application 210a and a network 104. More particularly, the interface manager 310 may implement the methods 400 and 500 to expose network status and functionality directly to the applications 210a-210c in the application plane 202, thereby allowing the applications 210a-210c to interact with the network 104, react to network performance and status, and influence network behavior in an efficient and holistic manner.

With reference first to method 400, at block 402, a request from an application 210a for access to a network 104 is received, for instance, by the request receiving module 312. The request may comprise any of a number of different types of requests. For instance, the request may comprise a query for a status of the network 104, which the application 210a may use to make decisions on how to work optimally across the available network behavior. As another example, the request may comprise a communication of policies and requirements that are to be applied in the network 104, which enable applications to define relevant delivery and access policies to the network 104 as well as negotiate with the network 104 for transmission and distribution services. Examples of the policies and requirements include defining latency, loss, bandwidth, reliability requirements (such as not sharing link risk group), defining load balancing policies, etc. As a further example, the request may comprise a request to insert services into the traffic forwarding process allowing the application 210a to analyze traffic and, based on privilege, allowing the application 210a to influence traffic forwarding decisions in the network 104.

At block 404, privileges assigned to the application 210a are determined, for instance, by the privileges determining module 316. The privileges generally pertain to the level of access the application 210a is to be provided to the network 104. Thus, for instance, the application 210a may be provided with no privileges, in which the application 210 is provided no access to even the status of the network 104. When an application 210a is provided no privileges, the application 210a may be able to communicate over the network 104, but may not be able to access status information of the network 104. As another example, the application 210a may be provided with a network transparency level of privileges, in which the application 210a may receive responses to queries for statuses of the network 104. In other words, the application 210a may be provided with a read-only type of access to the network 104. As a further example, the application 210a may be provided with a network interaction level of privileges, in which the application 210a may define relevant delivery and access policies to the network 104 as well as negotiate with the network 104 for transmission and distribution services. As a further example, the application 210a may be provided with a network insertion level of privileges, in which the application 210a may insert services into the traffic forwarding process.

The application 210a may be assigned any combination of the privileges discussed above. In addition, in one example, the privileges assigned to the application 210a are contained within the request or other communication received from the application 210a. In another example, the privileges determining module 316 may determine the privileges assigned to the application 210a by accessing a database containing information pertaining to the privileges assigned to the application 210a.

At block 406, the application 210a is provided with a level of access to the network 104 that corresponds to the determined privileges assigned to the application, for instance, by the access providing module 320. Thus, for instance, if the application 210a is not provided any privileges to access the network 104, the request for access to the network 104 by the application 210a may be denied.

As another example, if the application 210a has been assigned a network transparency level of privileges, the application 210a may be allowed to access to the status of the network 104. More particularly, the access providing module 320 of the interface manager 310 may include primitives that allow the application 210a to query the network 104 and view latency from source to destination or within the bounds of the controlled network 104. The primitives may also allow the application 210a, as well as operating systems, to query the network 104 and view available bandwidth capacities from source to destination or within the bounds of the controlled network 104. The primitives may further allow the application 210a to monitor the status of the communications flows associated with that application.

In one regard, and in contrast to traditional networking models, which depend entirely on packet loss to identify network performance problems to operating systems and applications, the interface manager 310 makes it possible for an application 210a or operating system to dynamically tune its own network behavior based on network performance. Interaction by the application 210a with the interface manager 310 thus allows the application 210a to optimize performance proactively rather than depending entirely on disruptive loss-based TCP mechanisms.

As a further example, if the application 210a has been assigned a network interaction level of privileges, the application 210a may be allowed to define relevant delivery and access policies to the network 104 as well as negotiate with the network 104 for transmission and distributional services. More particularly, the access providing module 320 of the interface manager 310 may include primitives that allow the application 210a to request a guaranteed transmission quality by specifying desired latency, bandwidth, and reliability metrics. According to an example, the access providing module 320 supports an iterative response allowing the network 104 to communicate the flow characteristics that the network 104 can support allowing the application 210a to either accept the proposed guarantee or await notification in the event that the requested delivery characteristics can be met. The primitives may also allow the application 210a to holistically define a policy by which traffic is distributed across destination nodes in the network 104. The primitives may further allow the application 210a to define a policy by which traffic is prioritized in transmission over the network 104. The primitives may still further allow the application 210a to request, in holistic terms, the path by which a traffic flow traverses the network 104.

By way of particular example, by making use of these network interactivity primitives in the interface manager 310, the application 210a may request that specific application flows, such as those associated with the ‘check-out’ functions of an e-commerce site, be distributed across a set of systems reserved for high-priority actions, forwarded over the network with a high priority and restricted to PCI compliant network paths while the anonymous browsing of a catalog is distributed across a smaller set of systems and delivered on a best effort basis over any available network path. As another example, the interface manager 310 may allow the application 210a to program the network 104 to send triggers to the application 210a when certain predefined conditions defined in the policies are met.

As a further example, if the application 210a has been assigned a network insertion level of privileges, the application 210a may be allowed to insert services into the traffic forwarding process of the network 104. More particularly, the access providing module 320 of the interface manager 310 may include primitives that allow the application 210a to insert itself into the forwarding process of new associated flows, thereby allowing the application 210a to influence how the traffic for a specific flow is forwarded across the network 104. The primitives may also allow the application 210a to insert itself into the forwarding process of all associated flows, thereby allowing the application 210a to monitor the contents of existing flows. The primitives may further allow the application 210a to alter the destination of a specific flow or set of flows in the network 104 on an ad hoc basis.

By way of example, by making use of these network insertion primitives, the application 210a may monitor specific application flows and, based on application state, may have individual flows or groups of flows redirected across the network 104 to facilitate more appropriate application handling or response.

Turning now to the method 500 in FIG. 5, there is shown a more detailed flow diagram of the method 400 for managing an interface between an application 210a and a network 104 depicted in FIG. 4. At block 502, a request for access to the network 104 is received from the application 210a, which is equivalent to block 402 in FIG. 4.

At block 504, a determination is made as to whether the application 210a is authentic, for instance, by the application authenticating module 314. The authenticity of the application 210a may be determined to determine whether the application 210a is authorized to access the network 104. The authentication of the application 210a may be performed through any of a plurality of suitable authentication procedures. For instance, a determination may be made as to whether the application 210a is listed as being authentic in a listing of applications. As another example, a determination may be made as to whether the application 210a contains an appropriate key or other identifier, which indicates that the application 210a is authentic.

In any regard, in response to a determination that the application 210a is not authentic, at block 506, access to the network 104 through the interface manager 310 may be denied, for instance, by the access providing module 320.

However, if the application 210a is determined to be authentic, at block 508, the privileges assigned to the application may be determined, for instance, by the privileges determining module 316, as discussed above with respect to block 404 in FIG. 4.

At block 510, a determination as to whether the request received at block 502 matches the privileges assigned to the application 210a is made, for instance, by the access providing module 320. In response to a determination that the request does not match the privileges assigned to the application 210a, the level of access to the network 104 contained in the request through the interface manager 310 may be denied, as indicated at block 506. Thus, for instance, if the application 210a has been assigned a network transparency level of privileges, but the request comprises a request for a network interaction, the access providing module 320 may deny the request.

In response to a determination that the request matches the privileges assigned to the application 210a, at block 512, a determination as to whether the request may be granted, for instance, by the request grant determining module 318. Particularly, the request grant determining module 318 may determine whether the network 104 is currently capable of granting the requested services. That is, for instance, the request grant determining module 318 may determine whether the network 104 currently has available resource, e.g., bandwidth, available processors, etc., to fulfill the request. In response to a determination that the network 104 may not perform the requested services, the application is informed, as indicated at block 514. The application may re-submit the request at block 502 or may drop the request, for instance, depending upon the importance of the requested service.

In response to a determination that the request may be granted, at block 516, the application 210a is provided with a level of access to the network 104 that corresponds to the determined privileges assigned to the application 210a, for instance, by the access providing module 320. The response to the request may comprise the responses discussed above with respect to block 406 in FIG. 4.

Some or all of the operations set forth in the methods 400 and 500 may be contained as a utility, program, or subprogram, in any desired computer accessible medium. In addition, the methods 400 and 500 may be embodied by machine readable instructions, which may exist in a variety of forms both active and inactive. For example, they may exist as source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

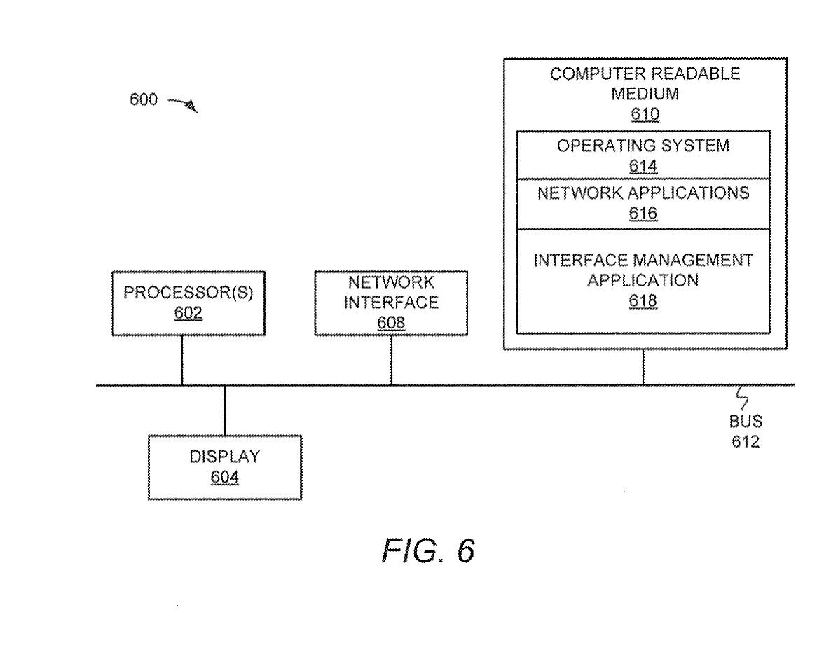

Turning now to FIG. 6, there is shown a schematic representation of a computing device 600, which may be employed to perform various functions of the interface manager 310 depicted in FIG. 3, according to an example. The computing device 600 includes a processor 602, such as the processor 602; a display 604, such as but not limited to a monitor; a network interface 608, such as but not limited to a Local Area Network LAN, a wireless 802.11x LAN, a 3G/4G mobile WAN or a WiMax WAN; and a computer-readable medium 610. Each of these components is operatively coupled to a bus 612. For example, the bus 612 may be an EISA, a PCI, a USB, a FireWire, a NuBus, or a PDS.

The computer readable medium 610 comprises any suitable medium that participates in providing instructions to the processor 602 for execution. For example, the computer readable medium 610 may be non-volatile media. The operating system 614 may also perform basic tasks such as but not limited to recognizing receipt of packets, transmitting the packets to their destination addresses, and managing traffic on the bus 612. The network applications 616 include various components for establishing and maintaining network connections, such as but not limited to machine readable instructions for implementing communication protocols including TCP/IP, HTTP, Ethernet, USB, and FireWire.

The interface management application 618 provides various components for managing an interface between an application and a network discussed above with respect to the methods 400 and 500 in FIGS. 4 and 5. The interface management application 618 may thus comprise the request receiving module 312, the application authenticating module 314, the privileges determining module 316, the request grant determining module 318, and the access providing module 320.

In certain examples, some or all of the processes performed by the application 618 may be integrated into the operating system 614. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for managing an interface between an application and a network, said method comprising:
receiving a request from the application for access to the network;
determining privileges assigned to the application; and
providing, by a processor, the application with a level of access to the network that corresponds to the determined privileges assigned to the application.

2. The method according to claim 1, further comprising:
determining whether the application is authentic;
providing the application with the level of access to the network that corresponds to the determined privileges assigned to the application; and
denying access to the network in response to a determination that the application is not authentic.

3. The method according to claim 1, wherein the privileges comprise at least one of no privileges, network transparency privileges, network interaction privileges, and network insertion privileges.

4. The method according to claim 3, wherein providing the application with the level of access to the network further comprises:
in response to the privileges comprising network transparency privileges, allowing the application to access a status of the network.

5. The method according to claim 3, wherein providing the application with the level of access to the network further comprises:
in response to the privileges comprising network interaction privileges, allowing the application to at least one of:
define delivery and access policies relevant to the application to the network; and
negotiate with the network for transmission and distributional services.

6. The method according to claim 3, wherein providing the application with the level of access to the network comprises:
in response to the privileges comprising network insertion privileges, allowing the application to insert services into network traffic of the network.

7. The method according to claim 1, wherein providing the application with the level of access to the network further comprises providing the application with access to a plurality of network-related databases.

8. The method according to claim 1, wherein providing the application with the level of access to the network further comprise providing the application with access to a network device controller application programming interface (API) through a network service.

9. The method according to claim 1, further comprising:
determining whether the request matches the privileges assigned to the application; and
denying the request in response to the request not matching the privileges assigned to the application.

10. The method according to claim 1, further comprising:
determining whether the level of access is able to be provided to the application; and
wherein providing the application with the level of access further comprises providing the application with the level of access in response to a determination that the network is able to provide the level of access to the application.

11. A network apparatus comprising:
a memory storing machine readable instructions to:
receive a request from the application for access to the network;
determine whether the application is authentic
determine privileges assigned to the application, wherein the privileges comprise at least one of no privileges, network transparency privileges, network interaction privileges, and network insertion privileges;
provide the application with a level of access to the network that corresponds to the determined privileges assigned to the application in response to a determination that the application is authentic; and
a processor to implement the machine readable instructions.

12. The network apparatus according to claim 11, wherein the machine readable instructions are further to:
in response to the privileges comprising network transparency privileges, allow the application to access a status of the network;
in response to the privileges comprising network interaction privileges, allow the application to at least one of:
define delivery and access policies relevant to the application to the network; and
negotiate with the network for transmission and distributional services; and
in response to the privileges comprising network insertion privileges, allow the application to insert services into network traffic of the network.

13. The network apparatus according to claim 11, wherein the machine readable instructions are further to one of:
provide the application with access to a plurality of network-related databases; and
provide the application with access to a network device controller application programming interface (API) through a network service.

14. A non-transitory computer readable storage medium on which is stored machine readable instructions, that when executed by a processor are to implement a method for managing an interface between an application and a network, said machine readable instructions comprising code to:
receive a request from the application for access to the network;
determine whether the application is authentic;
determine privileges assigned to the application;
determine whether the request matches the privileges assigned to the application; and
provide the application with a level of access to the network that corresponds to the determined privileges assigned to the application in response to a determination that the application authentic and that the request matches the privileges assigned to the application.

15. The non-transitory computer readable storage medium of claim 14, wherein the privileges comprise at least one of no privileges, network transparency privileges, network interaction privileges, and network insertion privileges, said machine readable instructions further comprising code to:
in response to the privileges comprising network transparency privileges, allow the application to access a status of the network;
in response to the privileges comprising network interaction privileges, allow the application to at least one of:
define delivery and access policies relevant to the application to the network; and
negotiate with the network for transmission and distributional services; and
in response to the privileges comprising network insertion privileges, allow the application to insert services into network traffic of the network.
